(19) United States
(12) Patent Application Publication
(10) Pub. No.: US 2001/0032070 A1
(43) Pub. Date: Oct. 18, 2001

(54) Apparatus and method for translating visual text

(76) Inventor: Mordechai Teicher, Hod Ha Sharon (IL)

Correspondence Address: Mordechai Teicher, c/o Creative Inputs Ltd., P.O. Box 991, Kfar Saba, 44109, IL

(21) Appl. No.: 09/754,767

(22) Filed: Dec. 28, 2000

Related U.S. Application Data
(60) Provisional application No. 60/175,319, filed on Jan. 10, 2000.

(51) Int. Cl. G06F 17/28

(52) U.S. Cl. 704/2; 382/181

(57) ABSTRACT

A digital video or still camera including optical character recognition and translator functions to translate text included in captured images. Cursor control allows the user to identify the desired text with the image. Translation is also possible on text included in images replayed from the camera's memory.

### FIELD AND BACKGROUND OF THE INVENTION

The present invention relates to digital cameras, and in particular to digital still and video cameras that translate, from one language to another, text included in captured images.

Leisure and business travelers reach foreign countries and encounter traffic signs, posters, restaurant menus, and other text written in a foreign language. To understand such text, visitors often use dictionaries in paper or electronic form. Such dictionaries require manual operation and are an additional piece of luggage to carry and bother with. Moreover, sometimes a dictionary is impractical altogether, if the user be unfamiliar with the writing system of the foreign language, such as in the case of a European visitor encountering text in Japanese, Hebrew, Chinese, or Arabic, or other written material that is not based on the Roman alphabet.

Some technologies which address this need are already known in the art, such as optical character recognition (OCR) for converting digital images of text into character codes; and automatic translators which transform character strings representing words or phrases in one language into the respective text in another language. For users on the go, an integrated portable scanner for reading and translating printed text is disclosed in U.S. Pat. No. 6,104,845 to Lipman et al. Compact hand-held text scanner/translators are also commercially-available, and enable users to scan text from newspapers, books, magazines, etc., and obtain rapid translation of words and phrases. A limitation of all such prior-art text scanners, however, is that they need to be in physical contact with the printed page in order to acquire the text of interest, and furthermore are slow and require tedious manipulation by the user to perform their scanning function. In addition, they represent an extra purchase of a piece of equipment, and can be an expense that is hard to justify for occasional or one-time use. Moreover, they are inherently limited to scanning text appearing in a narrow range of sizes and orientations. Such devices, for example, are unable to scan or translate text appearing on a television screen, billboard, poster, marquee, or traffic sign.

There is thus a widely recognized need for, and it would be highly advantageous to have, a text-based language translator that is inexpensive, convenient to carry on one's person while travelling, and which can rapidly capture and translate text appearing in a wide range of sizes and orientations without requiring physical contact or proximity to the text, and without requiring cumbersome manipulation by the user. These goals are met by the present invention.

### OBJECT AND SUMMARY OF THE INVENTION

An object of the present invention is to provide a translating device capable of automatic text translation for most forms of legible text, be they presented on posters, traffic signs, restaurant menus, paper, or in any other visible form, and in such a way that such automatic translation may be performed on text which is located at a selectable distance and at a selectable direction from the translating device. Another object of the present invention is to obviate the need for travelers to carry an extra piece of equipment whose sole purpose is translation. Still another object of the present invention is to reduce costs by utilizing the existing expensive electro-optical components and processing power included in digital cameras for the secondary purpose of capturing a text image and processing and displaying its translated equivalent. A further object of the present invention is to allow in-camera translation of images replayed from the camera's memory.

The present invention is an improved digital camera, non-limiting examples of which are a digital still camera, and a video camera employing a CCD (charge-coupled device) for capturing images in digital form. This camera is improved according to the present invention by including therewith an OCR (optical character recognition) unit to transform text captured by the camera into a string of character codes, and a translator unit to transform this text from one language to another. The translated text is then displayed on the camera's viewing screen. Text can also be translated from images replayed from the camera's memory.

Therefore, according to the present invention there is provided a portable translator for translating a first visual text in a first language into a second visual text in a second language, the portable translator including: (a) a viewfinder for aiming the portable translator in a selectable direction and from a selectable distance at an object whereupon the first visual text appears, and for identifying an image including a target area containing the first visual text; (b) an electro-optical image acquisition unit including a lens and a light-sensitive sensor operative to acquiring a digital representation of the target area; (c) an OCR unit operative to transforming the digital representation into a first string of character codes representative of the first visual text; (d) a translator unit including an electronic dictionary, the translator unit operative to transforming the first string of character codes into a second string of character codes representative of the second visual text; and (e) a display operative to showing the second visual text in accordance with the second string.

### BRIEF DESCRIPTION OF THE DRAWINGS

The invention is herein described, by way of example only, with reference to the accompanying drawings, wherein:

FIG. 1 is a schematic block diagram of a preferred embodiment of the present invention.

FIG. 2A is a schematic illustration of a captured image that includes text in a first language.

FIG. 2B is a schematic illustration of a camera's screen showing the captured image and the translation of the text in a first language into a second language.

FIG. 3A is a schematic illustration of a captured image wherein the text of interest occupied only a small part of the image.

FIG. 3B is a schematic illustration of a cursor used to identify the text of interest within the captured image.

FIG. 3C is a schematic illustration of s screen showing the captured image, the first-language text framed by the cursor, and the translated version of the first-language text into a second language.

FIG. 4 is a flowchart detailing the operation of the camera of the present invention for a captured image in accordance with FIG. 2A.

FIG. 5 is a flowchart detailing the operation of the camera of the present invention for a captured image in accordance with FIG. 3A.

FIG. 6 is a flowchart detailing the operation of the camera of the present invention for images replayed from the camera's memory.

### DESCRIPTION OF THE PREFERRED EMBODIMENTS

The principles and operation of a visual text translator according to the present invention may be understood with reference to the drawings and the accompanying description.

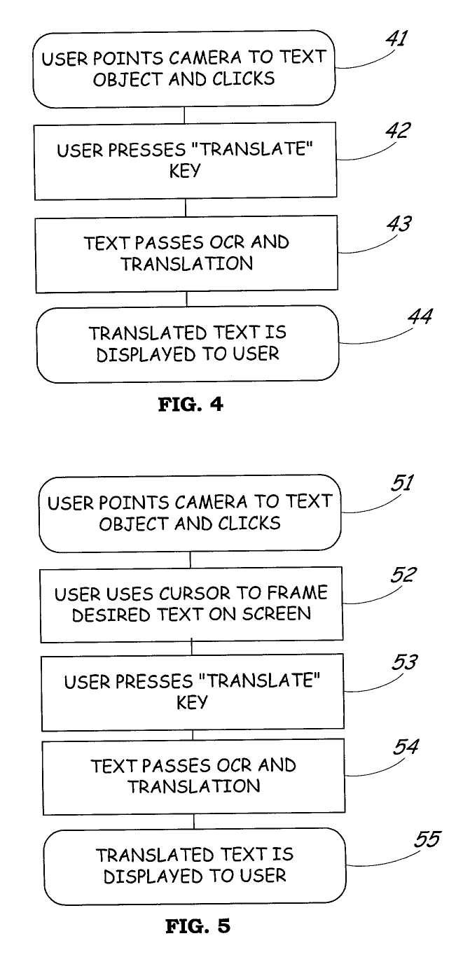

Reference is now made to FIG. 1, which illustrates a preferred embodiment of the present invention. A camera 1 is a video or digital still camera having a lens 3 and a charge-coupled device (CCD) 4 for capturing images electronically. A viewfinder 2 allows the user to accurately and conveniently point camera 1 at objects from variable distances and directions, and to determine the borders of the desired image. Lens 3 is preferably an autofocus zoom lens for convenience and control. A memory 6 includes a current image memory 7, which contains the digital representation of the image just captured by CCD 4 or of an image replayed from an image storage memory 8, which is able to keep a plurality of images previously taken by the user either as stills or as motion pictures. Image storage memory 8 is preferably a magnetic tape, a diskette, a flash solid state memory such as a “Solid-State Floppy Disk” (SSFD), or other memory medium capable of storing large amounts of data. A screen 5 allows the user to view images stored electronically in current image memory 7, and can also serve as viewfinder 2 as is commonly done with currently-available video and digital still cameras. A control panel 9 allows the user to operate the regular camera functions via a set of camera controls 11. Control panel 9 also includes a cursor control 12 for selectively specifying a part within the image displayed on screen 5. Non-limiting examples of cursor control 12 include cursor arrow buttons (up, down, left, and right) and miniature trackballs with keys, similar to those used with portable personal computers. A “Translate” key 10 is operated by the user to initiate the translation procedure according to the present invention, as is illustrated in FIGS. 4 to 6 below. An optical character recognition (OCR) unit 13 includes the processor and software needed to convert text included in the image stored in current image memory 7 from pixels into character codes (OCR technologies are well known in the art and are in common use.) A translator unit 14 includes a dictionary and software to translate words, and preferably to translate phrases also, from text in a source language to text in a target language. When receiving text in the first language from OCR unit 13, translator unit 14 will perform a translation and send the translated text to screen 5 for display. Translator unit 14 is preferably a removable module to allow changing the source and target languages, such as when traveling through different countries where different languages are used, or when camera 1 serves another user. Alternatively, multi-lingual dictionaries can be included in translator unit 14, for convenience when crossing borders.

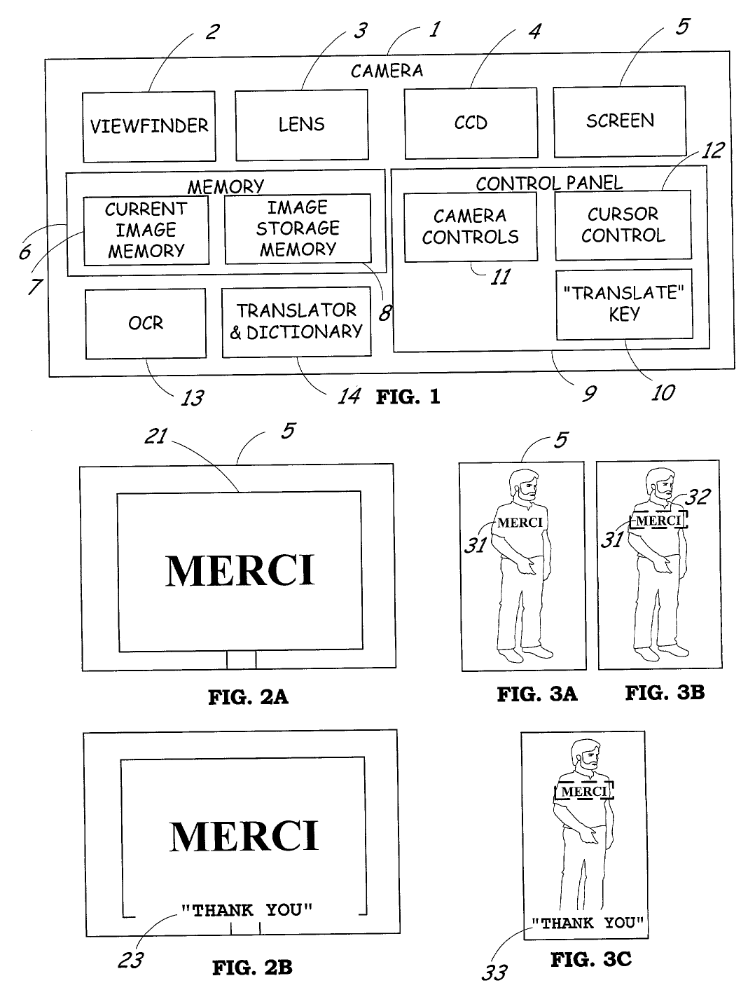

FIG. 2A illustrates a case where screen 5 shows a sign 21 which displays text in a first language (French). FIG. 2B illustrates screen 5 displaying translated text 23 after key 10 has been depressed and after OCR unit 13 has converted the text image into a string of character codes and translator unit 14 has produced translated text 23 in a second language (English) for display on screen 5.

FIG. 3A describes an image displayed on screen 5 wherein a text 31 occupies only a small part of the image area. FIG. 3B shows a frame 32 identifying text 31 as being of interest, and which isolates text 31 from non-text or other text objects included in the image. Frame 32 is drawn manually by the user using cursor control unit 12 to isolate the text of interest. FIG. 3C shows a translated text 33 that appears after the user presses “translate” key 10.

FIG. 4 illustrates a translation procedure suitable for a text object that occupies a major part in an image, such as the one shown in FIG. 2A. In a block 41 the user points the camera at the object and presses the shutter key, which captures the image and places a digital representation thereof in current image memory 7. In a block 42 the user presses “translate” key 10 on control panel 9, which, in a block 43, activates OCR unit 13 to scan image 21, identify the text, transform the text into character codes, and transfer the coded text for translation by translator unit 14. In a block 44 the translated text is displayed on screen 5, as shown in FIG. 2B.

FIG. 5 describes a translation procedure suitable for a text object that occupies a small part of the image, such as that of FIG. 3A. In a block 51 the image is captured and a digital representation thereof is placed in current image memory 7. In a block 52 cursor control unit 12 is operated to identify the text of interest and isolate the text from the rest of the image, which may also contain other text objects. In a block 53 “translate” key 10 is depressed, which activates OCR unit 13 in a block 54 and translator unit 14 in a block 55, to produce the translated text for display on screen 5.

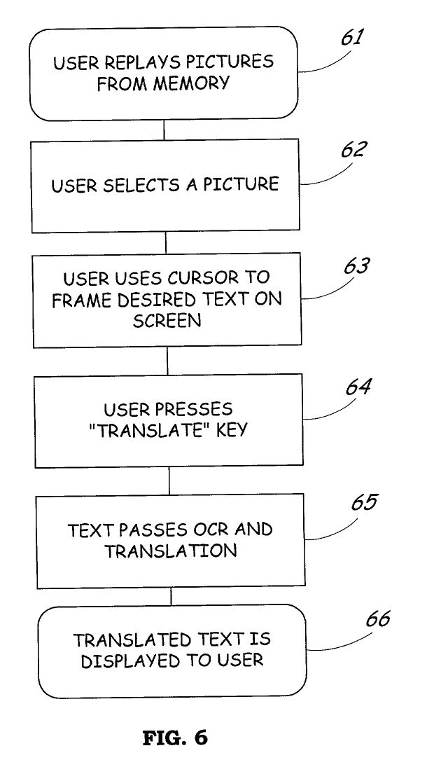

FIG. 6 describes a translation procedure similar to that of FIG. 5, but where the image is replayed from memory. In a block 61 the user browses through a collection of video or still images replayed from magnetic or solid state image storage memory 8. In a block 62 a specific image is selected and placed on screen 5 with a digital representation thereof placed in current image memory 7. In a block 63 cursor control unit 12 is used to isolate the desired text. In a block 64 “translate” key 10 is depressed, which activates OCR unit 13 in a block 65 and translator unit 14 in a block 66, to produce the translated text for display on screen 5.

While the invention has been described with respect to a limited number of embodiments, it will be appreciated that many variations, modifications and other applications of the invention may be made.

claims:

1. A portable translator for translating a first visual text in a first language into a second visual text in a second language, the portable translator comprising:
(a) a viewfinder for aiming the portable translator in a selectable direction and from a selectable distance at an object whereupon the first visual text appears, and for identifying an image including a target area containing the first visual text;
(b) an electro-optical image acquisition unit including a lens and a light-sensitive sensor operative to acquiring a digital representation of said target area;
(c) an OCR unit operative to transforming said digital representation into a first string of character codes representative of the first visual text;
(d) a translator unit including an electronic dictionary, said translator unit operative to transforming said first string of character codes into a second string of character codes representative of the second visual text; and
(e) a display operative to showing the second visual text in accordance with said second string.

2. The portable translator of claim 1 further comprising:
(f) a screen operative to showing said image; and
(g) a cursor control means for identifying said target area within said image.

3. The portable translator of claim 2 wherein said display forms part of said screen.

4. The portable unit of claim 2 wherein said viewfinder forms part of said screen.

5. The portable translator of claim 1 wherein said lens is a zoom lens.

6. The portable translator of claim 1 wherein said lens includes a focus means.

7. The portable translator of claim 6 wherein said focus means comprises an auto-focus control.

8. The portable translator of claim 1 further comprising a memory for recording a plurality of images.

9. The portable translator of claim 8 wherein said OCR unit is furthermore operable with images replayed from said memory.

10. The portable translator of claim 1 further comprising a light source operative to illuminating said target area.

11. An improved portable digital still camera for general still photography, including a viewfinder, a lens, an electronic light-sensitive sensor and a memory, for allowing a user to take a picture of a selected object and store the picture as a digital image in the memory, the improvement comprising a translator device included in the digital still camera and cooperating with the memory to transform a first text in a first language included in the digital image into a second text in a second language, wherein the digital still camera is operative to displaying said second text.

12. The improved portable digital still camera of claim 11 further comprising a cursor control means operable by the user to identify said first text within the digital image.

13. An improved portable digital video camera for general video motion photography, including a viewfinder, a lens, an electronic light-sensitive sensor and a memory, for allowing a user to take a picture of a selected object and store the picture as a digital image in the memory, the improvement comprising a translator device included in the digital video camera and cooperating with the memory to transform a first text in a first language included in the digital image into a second text in a second language, and wherein the digital video camera is operative to displaying said second text.

14. The improved portable digital video camera of claim 13 further comprising a cursor control means operable by said user to identify said first text within the digital image.

15. A method for employing a digital camera usable for general photography, the digital camera having a display, the method for translating a first text in a first language included in a digital image captured by the digital camera into a second text in a second language, the method comprising the steps of:
(a) providing an OCR unit within the digital camera to digitally process at least a selected part of the image to convert the first text into a first string of character codes;
(b) providing a translator unit within in the digital camera to translate said first string of character codes into a second string of character codes representative of the second language;
(c) sending said second string of character codes to the display and displaying said second string of character codes as the second text.

16. The method of claim 15 wherein said digital camera is a digital still camera.

17. The method of claim 15 wherein said digital camera is a digital video camera.
